(19) United States
(12) Patent Application Publication
(10) Pub. No.: US 2021/0268428 A1
(43) Pub. Date: Sep. 2, 2021

(54) ACID GAS ADSORBENT AND METHOD OF MANUFACTURING SAME

(71) Applicant: KAWASAKI JUKOGYO KABUSHIKI KAISHA, Kobe-shi, Hyogo (JP)

(72) Inventors: Ryohei NUMAGUCHI, Ashiya-shi (JP); Katsuhiro YOSHIZAWA, Akashi-shi (JP); Takeshi OKUMURA, Kobe-shi (JP); Shohei NISHIBE, Kobe-shi (JP); Ikuo SHIMOMURA, Kobe-shi (JP); Masahiro NEGAMI, Kobe-shi (JP)

(73) Assignee: KAWASAKI JUKOGYO KABUSHIKI KAISHA, Kobe-shi, Hyogo (JP)

(21) Appl. No.: 17/267,644

(22) PCT Filed: Nov. 6, 2019
(86) PCT No.: PCT/JP2019/043439

§ 371 Date: Feb. 10, 2021

(30) Foreign Application Priority Data
Nov. 7, 2018 (JP) 2018-210019

(51) Int. Cl. B01D 53/14; B01J 20/28; B01J 20/30

(52) U.S. Cl. CPC B01D 53/1456; B01J 20/28083; B01J 20/28085; B01J 20/30; B01D 2252/20489; B01D 2257/504; B01D 2253/25; B01D 2253/304; B01D 2253/308; B01D 2253/31; B01D 2253/311; B01D 2253/104

(57) ABSTRACT

An acid gas adsorbent that reversibly adsorbs an acid gas contained in a gas to be processed includes: metal oxide porous material particles; and an acid gas adsorbing agent with which the porous material particles are impregnated. Each of the porous material particles has binary pores including: a mesopore having a pore diameter in a nanometer region of 2 nm or more and 200 nm or less; and a macropore having a pore diameter in a micrometer region of more than 0.2 μm. The macropore is an empty pore, and the mesopore is filled with the acid gas adsorbing agent.

### TECHNICAL FIELD

The present invention relates to an acid gas adsorbent which reversibly adsorbs an acid gas contained in a gas to be processed and a method of manufacturing the acid gas adsorbent.

### BACKGROUND ART

Conventionally known is an acid gas adsorbent formed by a porous support impregnated with amine as a liquid-state chemical substance which selectively absorbs an acid gas. Examples of the acid gas include hydrogen sulfide (H₂S), carbon dioxide (CO₂), sulfur oxide (SOx), and nitrogen oxide (NOx). Each of PTLs 1 and 2 discloses such acid gas adsorbent and a system of separating and collecting the acid gas from a gas to be processed by using the acid gas adsorbent.

An adsorbing agent substance described in PTL 1 contains at least one amine, at least one carbon dioxide activation catalyst, and at least one porous substance supporting the at least one amine and the at least one catalyst. Moreover, the system of separating and collecting carbon dioxide from a process gas in PTL 1 includes at least one adsorbing container, and the process gas is supplied through the adsorbing container. The adsorbing container is filled with the adsorbing agent substance, and the adsorbing agent substance reversibly adsorbs the carbon dioxide from the process gas supplied through the adsorbing agent substance.

A carbon dioxide adsorbent described in PTL 2 is a porous substance impregnated with amine. Examples of the porous substance include activated carbon and activated alumina. A carbon dioxide separator described in PTL 2 includes a hopper, an adsorption tower, a desorption tower (regeneration tower), a drying tower, and a cooling tower which are liner up in order toward a lower side in an upper-lower direction. As the carbon dioxide adsorbent moves downward from the hopper through the towers in order, the carbon dioxide adsorbent adsorbs the carbon dioxide from the gas to be processed in the adsorption tower and discharges the adsorbed carbon dioxide in the desorption tower.

### CITATION LIST

### Patent Literature

PTL 1: Published Japanese Translation of PCT Application No. 2012-501831

PTL 2: Japanese Laid-Open Patent Application Publication No. 2013-121562

### SUMMARY OF INVENTION

### Technical Problem

In the system of selectively separating and collecting the acid gas from the gas to be processed by using the acid gas adsorbent in PTLs 1 and 2, in order to increase the amount of acid gas collected, it is important to increase an acid gas adsorption speed of the acid gas adsorbent. Therefore, the present invention provides an acid gas adsorbent which realizes the increase in the acid gas adsorption speed, and a method of manufacturing the acid gas adsorbent.

### Solution to Problem

Conventionally, a pore diameter and pore volume of a porous support have been regarded as factors which influence the acid gas adsorption speed. Therefore, a porous material having large pore volume has been adopted for the purpose of the improvement of the saturated adsorption amount of acid gas. However, it has been difficult to increase the acid gas adsorption speed of the acid gas adsorbent only by the increase in the pore volume of the porous support.

An acid gas adsorbent according to one aspect of the present invention is an acid gas adsorbent that reversibly adsorbs an acid gas contained in a gas to be processed, the acid gas adsorbent including: porous material particles; and an acid gas adsorbing agent with which the porous material particles are impregnated. Each of the porous material particles has binary pores including a mesopore having a pore diameter in a nanometer region of 2 nm or more and 200 nm or less and a macropore having a pore diameter in a micrometer region of more than 0.2 μm. The macropore is an empty pore. The mesopore is filled with the acid gas adsorbing agent.

A method of manufacturing an acid gas adsorbent according to another aspect of the present invention is a method of manufacturing an acid gas adsorbent that reversibly adsorbs an acid gas contained in a gas to be processed, the method including: dissolving an acid gas adsorbing agent in a solvent to prepare an adsorbing agent solution; impregnating porous material particles with the adsorbing agent solution; and drying the porous material particles impregnated with the adsorbing agent solution by aeration or under reduced pressure. Each of the porous material particles has binary pores including a mesopore having a pore diameter in a nanometer region of 2 nm or more and 200 nm or less and a macropore having a pore diameter in a micrometer region of more than 0.2 μm.

According to the acid gas adsorbent and the method of manufacturing the acid gas adsorbent, the acid gas adsorbent includes: the macropore that is an empty pore; and the mesopore filled with the acid gas adsorbing agent. Since the inside of the macropore is utilized as a place where the gas to be processed moves, the diffusion of the acid gas to the acid gas adsorbing agent filled in the mesopore can be made quick. Therefore, the acid gas adsorption speed of the acid gas adsorbent can be increased. It should be noted that a rule of pore classification of the mesopore and the macropore in the acid gas adsorbent and the method of manufacturing the acid gas adsorbent is different from a rule of pore classification of IUPAC (International Union of Pure and Applied Chemistry).

In the above method of manufacturing the acid gas adsorbent, a concentration of the acid gas adsorbing agent of the adsorbing agent solution may be represented by

αρx/(x+y) [Kg/m³]

where x [m³/Kg] denotes a pore volume of the mesopore, y [m³/Kg] denotes a pore volume of the macropore, ρ [Kg/m³] denotes a liquid density of the acid gas adsorbing agent, and α denotes an adjustment coefficient of 0.8 or more and 1.2 or less.

By adjusting the concentration of the adsorbing agent solution as above, the macropore of the acid gas adsorbent can be more surely made to become an empty pore.

In the above acid gas adsorbent and the method of manufacturing the acid gas adsorbent, an average particle size of the porous material particles may be 1 mm or more and 5 mm or less.

With this, the average particle size of the acid gas adsorbent becomes substantially 1 mm or more and 5 mm or less. The acid gas adsorbent can obtain handleability and flowability suitable for use in a system of separating the acid gas from the gas to be processed or separating and collecting the acid gas from the gas to be processed.

In the above acid gas adsorbent and the method of manufacturing the acid gas adsorbent, a Log differential pore volume distribution of the porous material particles may include a first peak in a range of 10 nm or more and 200 nm or less and a second peak in a range of more than 0.2 μm and 10 μm or less.

According to this, the porous material particle includes the macropore and the mesopore which are suitable as the support of the acid gas adsorbent.

In the above acid gas adsorbent and the method of manufacturing the acid gas adsorbent, the porous material particles may be made of at least one selected from the group consisting of silica, alumina, titania, zirconia, and magnesia.

In the above acid gas adsorbent and the method of manufacturing the acid gas adsorbent, the acid gas adsorbing agent may be at least one selected from the group consisting of alkanolamines and polyamines.

### Advantageous Effects of Invention

The present invention can provide an acid gas adsorbent which realizes an increase in an acid gas adsorption speed, and a method of manufacturing the acid gas adsorbent.

### BRIEF DESCRIPTION OF DRAWINGS

FIG. 1 is a schematic sectional view of a particle of an acid gas adsorbent according to the present embodiment.

FIG. 2 is a graph showing a Log differential pore volume distribution of porous material particles.

FIG. 3 is a schematic sectional view of the porous material particle impregnated with an adsorbing agent solution.

FIG. 4 is a schematic sectional view of the porous material particle after the adsorbing agent solution is dried.

FIG. 5 is a schematic sectional view of the particle of the acid gas adsorbent according to Comparative Example.

FIG. 6 is a graph showing a carbon dioxide adsorption curve of a comparative sample.

FIG. 7 is a graph showing a carbon dioxide adsorption curve fitting of the comparative sample.

### DESCRIPTION OF EMBODIMENTS

An acid gas adsorbent according to the present embodiment can reversibly adsorb an acid gas from an acid gas-containing gas to be processed and desorb the adsorbed acid gas. The acid gas may be at least one of hydrogen sulfide (H₂S), carbon dioxide (CO₂), sulfur oxide (SOx), and nitrogen oxide (NOx). Such acid gas adsorbent is suitably used in a system of separating the acid gas from the gas to be processed or separating and collecting the acid gas from the gas to be processed.

Structure of Acid Gas Adsorbent 1

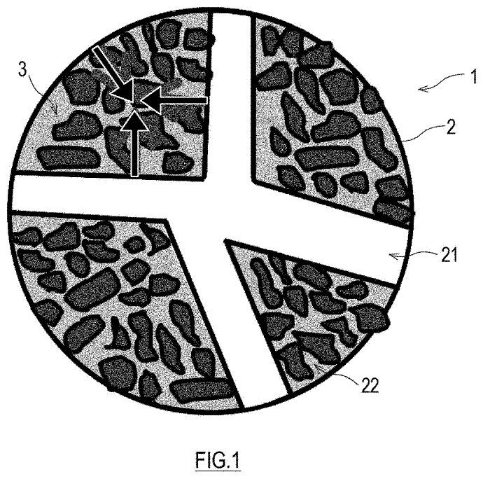

FIG. 1 is a schematic sectional view of a particle of an acid gas adsorbent 1 according to the present embodiment. The acid gas adsorbent 1 shown in FIG. 1 includes: porous material particles 2 as supports; and an acid gas adsorbing agent 3 (hereinafter simply referred to as an “adsorbing agent 3”) with which the porous material particles 2 are impregnated. Each of the porous material particles 2 has binary pores including macropores 21 and mesopores 22. The mesopores 22 are filled with the adsorbing agent 3, and the macropores 21 are empty pores. However, the adsorbing agent 3 may partially remain in the macropores 21.

Acid Gas Adsorbing Agent 3

The adsorbing agent 3 is an amine. The amine is at least one selected from the group consisting of alkanolamines and polyamines. To be specific, the above amine may contain a mixture of alkanolamines and polyamines. It is known that these alkanolamines and polyamines reversibly desorb the acid gas, i.e., adsorb and discharge (desorb) the acid gas. Examples of the alkanolamines include monoethanolamine, diethanolamine, and triethanolamine. Moreover, examples of the polyamines include polyethylenimine, ethylenediamine, diethylenetriamine, triethylenetetramine, tetraethylenepentamine, and pentaethylenehexamine.

Porous Material Particle 2

The porous material particle 2 is a particulate metal oxide or a particulate composite material.

The metal oxide is at least one selected from the group consisting of silica (silicon dioxide; SiO₂), alumina (aluminum oxide; Al₂O₃), titania (titanium dioxide; TiO₂), zirconia (zirconium dioxide; ZrO₂), and magnesia (magnesium oxide; MgO). Such metal oxide is suitable as a support of the adsorbing agent 3.

The particulate composite material is a porous material particle in which hydrophilic fiber and powdery porous material are combined with each other by hydrophilic binder. Examples of the hydrophilic fiber include cellulose fiber containing cellulose or cellulose derivative, polyvinyl alcohol fiber, and polyamide fiber. A fiber length of the hydrophilic fiber may be 0.1 to 10 mm. A fiber diameter of the hydrophilic fiber may be 1.0 to 20 μm. The content of the hydrophilic fiber in the total mass of the porous material particles may be 5 mass % or more and 50 mass % or less. The powdery porous material is at least one selected from the group consisting of silica (such as silica gel and mesoporous silica), alumina (such as activated alumina), zeolite, activated carbon, and metal-organic frameworks (MOF). The content of the powdery porous material in the total mass of the porous material particles may be 30 mass % or more and 85 mass % or less. An average particle size of the powdery porous material is 1 μm or more and 200 μm or less, preferably 5 μm or more and 150 μm or less. The hydrophilic binder has hydrophilicity and strongly bonds the hydrophilic fiber and the powdery porous material together. The hydrophilic binder has water insolubility. It should be noted that the “hydrophilicity” of the binder means that 1 g or more of the binder dissolves in 100 g of water having a temperature of 20° C. The content of the hydrophilic binder in the total mass of the porous material particles may be 0.5 to 30 weight %. The hydrophilic binder is at least one selected from the group consisting of water-soluble polymers (such as starch, methyl cellulose, carboxymethyl cellulose, alginic acid, guar gum, gum arabic, agar, carrageenan, polyacrylic acid, polyvinyl alcohol, and polyethylene glycol) which have been made water-insoluble. It should be noted that the water-soluble polymers are made water-insoluble by crosslinking, salt exchange, introduction of hydrophobic functional group, phase transition, or the like.

In the present description and claims, the mesopore 22 is a pore having a pore diameter in a nanometer region of 2 nm or more and 200 nm or less. Moreover, in the present description and claims, the macropore 21 is a pore having a pore diameter in a micrometer region of more than 0.2 μm. In the porous material particle 2 according to the present embodiment, the diameter of the macropore 21 is desirably 10 μm or less based on the relationship with the average particle size of the porous material particles 2. The pore diameter of the porous material particle 2 may be measured with a mercury porosimeter.

A Log differential pore volume distribution of the porous material particles 2 has a first peak in a range of 10 nm or more and 200 nm or less and a second peak in a range of more than 0.2 μm and 10 μm or less.

A Log differential pore volume distribution dV/d (log D) is obtained by: dividing a differential pore volume dV by a differential value d (log D) that is treated as a logarithm of the pore diameter; and plotting the obtained values with respect to average pore diameters in respective sections. A pore diameter distribution of the porous material particles 2 may be calculated by a mercury intrusion method. The mercury intrusion method is a method in which: by utilizing high surface tension of mercury, pressure is applied such that the mercury intrudes in pores of fine particles; and a specific surface area and a pore distribution are obtained from the pressure and the amount of intruded mercury.

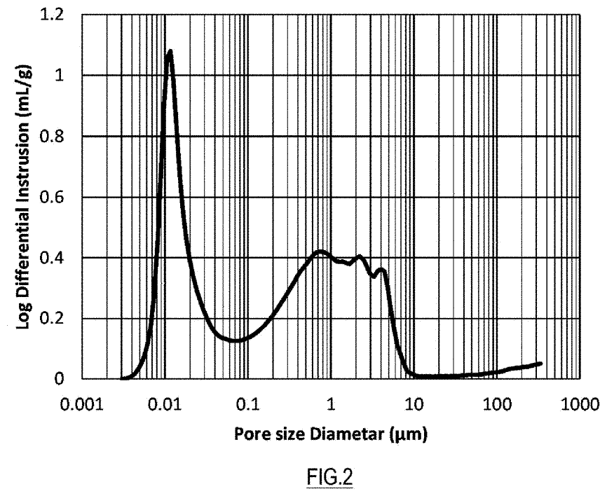

FIG. 2 is a graph showing one example of the Log differential pore volume distribution of the porous material particles 2. This graph shows results obtained by measuring a spherical composite material as one example of the porous material particle with a micromeritics pore distribution measuring device (Autopore 9520) produced by Shimadzu Corporation. The above spherical composite material is prepared in such a manner that: a kneaded product is formed by activated alumina fine powder (average particle size of 150 μm or less; VGL-15 produced by Union Showa K.K.) as the powdery porous material, chemical pulp (CP; average fiber length of about 3 mm and fiber diameter of about 10 μm) as the hydrophilic fiber, and polyvinyl alcohol as the hydrophilic binder; the kneaded product is extruded with an extruder to form pellets; the pellets are granulated into particles each having a spherical shape with a granulator; and the particles are dried. The content rate of the powdery porous material in the kneaded product is 72 mass %, and the content rate of the hydrophilic fiber and the hydrophilic binder is 28 mass %. The diameter of the spherical composite material is about 3 mm.

In the Log differential pore volume distribution shown in FIG. 2, there is the first peak in a pore diameter range of 10 nm or more and 200 nm or less and the second peak in a pore diameter range of more than 0.2 μm and 10 μm or less. Both the first peak and the second peak are remarkable peaks, and the pore volume of the macropore 21 and the pore volume of the mesopore 22 in the porous material particle 2 are clearly shown. The porous material particle having such Log differential pore volume distribution includes the macropores 21 and the mesopores 22 which are suitable as the support of the acid gas adsorbent 1.

A method of producing the porous material particle 2 having the binary pores including the macropores 21 and the mesopores 22 is not especially limited, and a known method may be adopted. Known as one example of such method is a method of producing binary pore silica including macropores and mesopores in such a manner that: a sol solution containing silicon source, water-soluble polymer, and acid is gelated during phase separation; the obtained gel body is immersed in an alkaline solution to be washed; and then the gel body is dried. Regarding such method of producing the porous material particle 2, Japanese Laid-Open Patent Application Publication No. 2006-104016 and Japanese Laid-Open Patent Application Publication No. 2008-179520 are incorporated by reference. Moreover, for example, the porous material particle 2 having the binary pores including the macropores and the mesopores may be produced in such a manner that the powdery porous material is solidified by a water-soluble polymer binder, such as polyvinyl alcohol, granulated, and dried. Furthermore, for example, the porous material particle 2 having the binary pores including the macropores and the mesopores may be produced in such a manner that the powdery porous material is solidified by an inorganic binding agent, such as metalalkoxide, granulated, and sintered.

A ratio (macropore volume/mesopore volume) of the pore volume (total) of the macropores 21 of the porous material particle 2 to the pore volume (total) of the mesopores 22 of the porous material particle 2 is preferably 0.5 or more and 5 or less. When the ratio is less than 0.5, the macropores 21 are inadequate. Therefore, channels of the gas to be processed flowing into the porous material particle 2 cannot be adequately secured, and an adsorption speed promoting effect is inadequate. On the other hand, when the ratio (macropore volume/mesopore volume) exceeds 0.5, the macropores 21 are too many. Therefore, the strength of the porous material particle 2 deteriorates. It should be noted that in some cases, a sintered body of alumina powder incidentally obtains binary pores. In this case, the ratio of the macropore volume to the mesopore volume is less than 0.5.

The average particle size of the porous material particles 2 is desirably 1 mm or more and 5 mm or less.

When the porous material particle 2 having such average particle size is used, the average particle size of the acid gas adsorbent 1 also becomes about 1 mm or more and 5 mm or less. The acid gas adsorbent 1 has handleability and flowability suitable for use in the system of separating the acid gas from the gas to be processed or separating and collecting the acid gas from the gas to be processed. The above system adopts a fixed bed in which the acid gas adsorbent 1 is made stationary, and the gas to be processed is supplied to gaps of the acid gas adsorbent 1 or a moving bed in which the acid gas adsorbent 1 is moved downward by gravity, and the gas to be processed is supplied to the gaps of the acid gas adsorbent 1. When the particle size of the acid gas adsorbent 1 is smaller than 1 mm, the acid gas adsorbent 1 may fluidize at a low flow rate of the gas to be processed, and satisfactory contact between the acid gas adsorbent 1 and the gas to be processed may not be maintained. In contrast, when the particle size of the acid gas adsorbent 1 exceeds 5 mm, the weight of the acid gas adsorbent 1 increases as the particle size increases, and therefore, the wear of the acid gas adsorbent 1 by impact may become severe when the acid gas adsorbent 1 is loaded onto a processing container or when the acid gas adsorbent 1 flows in the moving bed. Thus, the life of the acid gas adsorbent 1 may significantly decrease.

The “particle size” of the porous material particle 2 denotes the diameter of the particle. The particle size of the porous material particle 2 can be measured by the following steps (1) to (4).

(1) 100 or more porous material particles as a sample are arranged on a black felt such that the particles do not contact each other as much as possible.

(2) An image of the porous material particles as the sample is taken in a range of vision of 100 mm×140 mm.

(3) The area of each particle is calculated by binarizing the taken image using image processing software ImageJ (National Institutes of Health (NIH)).

(4) The particle size is calculated from the obtained area of the particle on the presumption that the porous material particle has a true spherical shape.

A number average size (=Σ(particle size)/(number of particles evaluated)) may be calculated from the obtained particle size, and this number average size may be used as the average particle size.

Method of Manufacturing Acid Gas Adsorbent 1

A method of manufacturing the acid gas adsorbent 1 will be described below.

Manufacturing steps of the acid gas adsorbent 1 include the following steps (1) to (3).

(1) Adsorbing Agent Solution Preparing Step: An amine as an acid gas adsorbing agent is dissolved in a solvent (water or alcohol) to prepare an adsorbing agent solution. The temperature of the adsorbing agent solution is desirably 10° C. or more and 100° C. or less.

(2) Impregnating Step: Porous material particles are put into an immersion container filled with the adsorbing agent solution, and the porous material particles are impregnated with the adsorbing agent solution. An immersion time of the porous material particles can be set to, for example, 24 hours such that the insides of the pores are adequately degassed. In order to shorten the immersion time, the adsorbing agent solution may be stirred, or ultrasonic vibration may be applied to the immersion container.

(3) Drying Step: The porous material particles are taken out from the adsorbing agent solution, and adhered excess liquid is removed by a method, such as suction filtration. Then, the porous material particles impregnated with the adsorbing agent solution are dried at a temperature close to room temperature by aeration or under reduced pressure.

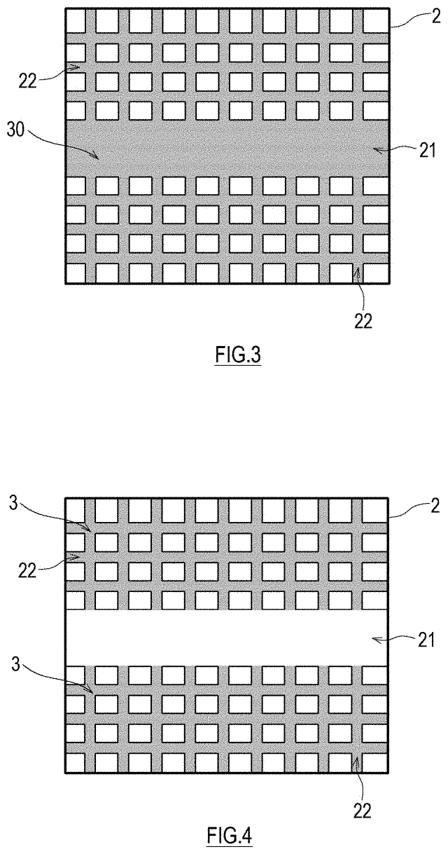

In the above (3) that is the drying step, as shown in FIG. 3, the adsorbing agent solution 30 spreads all over the macropores 21 and the mesopores 22 in the porous material particle 2 impregnated with the adsorbing agent solution 30. When the porous material particle impregnated with the adsorbing agent solution is dried, the solvent volatilizes and is desorbed from the adsorbing agent solution in the pores of the porous material particle, and therefore, only the adsorbent remains in the pores. In this case, the adsorbing agent agglomerates, and the volume thereof decreases. Then, the mesopores having smaller pore diameters are first filled with the adsorbing agent by the surface tension. To be specific, first, the mesopores are filled with the adsorbing agent, and after the mesopores are filled with the adsorbing agent (when the adsorbing agent is still remaining), the adsorbing agent then fills the macropores.

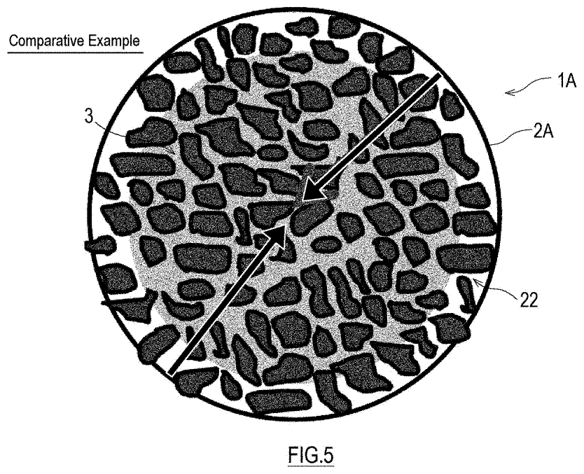

Since the adsorbing agent solution with which the porous material particle 2 is impregnated is dried as above, as shown in FIG. 4, in the porous material particle 2 from which the adsorbing agent solution 30 is dried, i.e., in the acid gas adsorbent 1, the macropore 21 tends to become an empty pore. In order that the macropore 21 surely becomes the empty pore, in the above (1) that is the adsorbing agent solution preparing step, the concentration of the adsorbing agent (amine) of the adsorbing agent solution may be adjusted as below.

A pore volume x [m³/Kg] of the mesopores 22 and a pore volume y [m³/Kg] of the macropores 21 in the porous material particle 2 are measured in advance. A liquid density ρ [Kg/m³] of the adsorbing agent is known. A concentration C [Kg/m³] of the adsorbing agent of the adsorbing agent solution is adjusted so as to be represented by Formula 1 below.

C=ρx/(x+y) Formula 1

It should be noted that an actual concentration C′ [Kg/m³] of the adsorbing agent of the adsorbing agent solution may be obtained by adjusting the theoretical concentration C [Kg/m³] by about ±20%. To be specific, the concentration C′ [Kg/m³] of the adsorbing agent of the adsorbing agent solution is represented by Formula 2 below where α denotes an arbitrary adjustment coefficient that is 0.8 or more and 1.2 or less.

C′=αρx/(x+y) Formula 2

Actions of Acid Gas Adsorbent 1

Actions of the acid gas adsorbent 1 will be described while being compared with those of an acid gas adsorbent 1A of Comparative Example. FIG. 5 is a schematic sectional view of a particle of the acid gas adsorbent 1A according to Comparative Example.

The acid gas adsorbent 1A according to Comparative Example shown in FIG. 5 includes: a porous material particle 2A as the support; and the adsorbing agent 3 with which the porous material particle 2A is impregnated. The acid gas adsorbent 1A according to Comparative Example is different from the acid gas adsorbent 1 according to the embodiment in that the porous material particle 2A does not include the macropores 21 but includes only the mesopores 22.

When the acid gas adsorbent 1 is placed in the acid gas-containing gas to be processed, the gas to be processed contacts an outer surface of the acid gas adsorbent 1 and flows into the pores of the acid gas adsorbent 1. The insides of the macropores 21 that are the empty pores become places where the gas to be processed moves. Therefore, the gas to be processed can contact the adsorbing agent 3 on the outer surface of the acid gas adsorbent 1 and inner walls of the macropores 21, and therefore, can diffuse from the outer surface of the acid gas adsorbent 1 and the inner walls of the macropores 21 to the adsorbing agent 3 filled in the mesopores 22.

On the other hand, in the acid gas adsorbent 1A according to Comparative Example, the gas to be processed can contact the outer surface of the acid gas adsorbent 1 and diffuse from the outer surface of the acid gas adsorbent 1 to the adsorbing agent 3 filled in the mesopores 22. As above, the contact area of the gas to be processed in the acid gas adsorbent 1 according to the embodiment is larger than that in the acid gas adsorbent 1A according to Comparative Example, and the gas to be processed can diffuse from the insides of the particles in the acid gas adsorbent 1 according to the embodiment. With this, an adsorption speed of the acid gas in the acid gas adsorbent 1 according to the embodiment becomes higher than that in the acid gas adsorbent 1A according to Comparative Example.

When the adsorbed acid gas is desorbed from the acid gas adsorbent 1, the acid gas adsorbent 1 is heated or is brought into contact with steam. In the case of heating the acid gas adsorbent 1, the surface area from which the acid gas can be discharged is larger in the acid gas adsorbent 1 according to the embodiment than in the acid gas adsorbent 1A according to Comparative Example. In addition to this, in the acid gas adsorbent 1 according to the embodiment, the adsorbed acid gas can be discharged from the inner walls of the macropores 21 of the particle, and the acid gas can be made to move through the macropores 21 to an outside of the particle. Moreover, in the case of bringing the acid gas adsorbent 1 into contact with the steam, the contact area with which the steam contacts is larger in the acid gas adsorbent 1 according to the embodiment than in the acid gas adsorbent 1A according to Comparative Example. In addition, in the acid gas adsorbent 1 according to the embodiment, the inner walls of the macropores 21 in the particle can also contact the steam, and the acid gas can be desorbed also from the inner walls of the macropores 21. Then, the acid gas can be made to move through the macropores 21 to an outside of the particle. As above, a desorbing (desorption) speed of the acid gas in the acid gas adsorbent 1 according to the embodiment becomes higher than that in the acid gas adsorbent 1A according to Comparative Example.

### Verification

The following will verify an effect in which the acid gas adsorption speed of the acid gas adsorbent 1 improves since the porous material particle 2 includes the macropores 21 in addition to the mesopores 22. For this verification, samples 1 to 4 according to Verification Examples 1 to 4 and a comparative sample according to Comparative Example were prepared. The properties of the samples 1 to 4 and the comparative sample are shown in Table 1.

### Verification Example 1

The sample 1 that is the acid gas adsorbent according to Verification Example 1 was prepared in such a manner that an alumina sintered body having a macropore diameter controlled by a spacer was impregnated with diethanolamine (DEA), the alumina sintered body being described in “Materials Research Bulletin”, Vol. 39, Issue 13, Pages. 2103-2112, Y. Kim et al., (2 Nov. 2004).”

### Verification Example 2

The sample 2 that is the acid gas adsorbent according to Verification Example 2 was prepared in such a manner that silica gel having macropores generated by adding polymer to liquid glass was impregnated with diethanolamine (DEA), the silica gel being described in “Japanese Laid-Open Patent Application Publication No. 2006-104016.”

### Verification Example 3

The sample 3 that is the acid gas adsorbent according to Verification Example 3 was prepared in such a manner that titania having a layered structure formed by a dropping method was impregnated with diethanolamine (DEA), the titania being described in “Advanced Functional Materials”, Vol. 17, Issue 12, Pages. 1984-1990, J. Yu et al., (August, 2007).”

### Verification Example 4

A porous material particle was prepared in such a manner that: a kneaded product was formed by activated alumina fine powder (average particle size of 150 μm or less; VGL-15 produced by Union Showa K.K.) as the powdery porous material, chemical pulp (CP; average fiber length of about 3 mm and fiber diameter of about 10 μm) as the hydrophilic fiber, and polyvinyl alcohol as the hydrophilic binder; the kneaded product is extruded with an extruder to form pellets; the pellets are granulated into particles each having a spherical shape with a granulator; and the particles are dried. The content rate of the powdery porous material in the kneaded product is 72 mass %, and the content rate of the hydrophilic fiber and the hydrophilic binder is 28 mass %. The diameter of the porous material particle is about 3 mm. The sample 4 that is the acid gas adsorbent according to Verification Example 4 was prepared in such a manner that the porous material particle was impregnated with diethanolamine (DEA).

### Comparative Example

The comparative sample that is the acid gas adsorbent according to Comparative Example was prepared in such a manner that silica gel (average particle size of 1.18 mm and average pore diameter of 30 nm; CARiACT Q30 produced by Fuji Silysia Chemical Ltd.) having only the mesopores was made to support diethanolamine (DEA).

TABLE 1

| | Comparative | | | | |
|---|---|---|---|---|---|
| | Example | Sample 1 | Sample 2 | Sample 3 | Sample 4 |
| Constituent material | Silica | Alumina | Silica | Titania | Alumina/cellulose |
| | | | | | composite |
| Mesopore diameter | 30 | 17.2 | 8 | 4.8 | 14 |
| [nm] | | | | | |
| Mesopore volume | 1.0 × 10⁻³ | 0.84 × 10⁻³ | 1.4 × 10⁻³ | 0.13 × 10⁻³ | 0.39 × 10⁻³ |
| [m³/Kg] | | | | | |
| Macropore diameter | — | 5 | 1 | 2.5 | 0.56 |
| [μm] | | | | | |
| Macropore porosity | — | 0.4 | 0.5 | 0.5 | 0.3 |
| Average particle size | 1.18 | 1.18 | 1.18 | 1.18 | 1.7 |
| [mm] | | | | | |
| Acid gas adsorbing | DEA | DEA | DEA | DEA | DEA |
| agent | | | | | |

The acid gas adsorption speeds of the comparative sample and the samples 1 to 4 were measured with a thermogravimetry device, and based on these measurement results, acceleration effects of the acid gas adsorption speeds of the respective samples were evaluated. The thermogravimetry device includes: a furnace having a temperature that is kept constant; a basket provided in the furnace; and a mass meter configured to measure the mass of the basket. Each sample was placed on the basket of the thermogravimetry device, and the sample and the acid gas-containing gas to be processed were brought into contact with each other. Then, the change in the mass of the sample by the adsorption of the acid gas was measured. The gas to be processed is formed by 13 volume % of carbon dioxide (CO₂) and nitrogen (N₂) for balance.

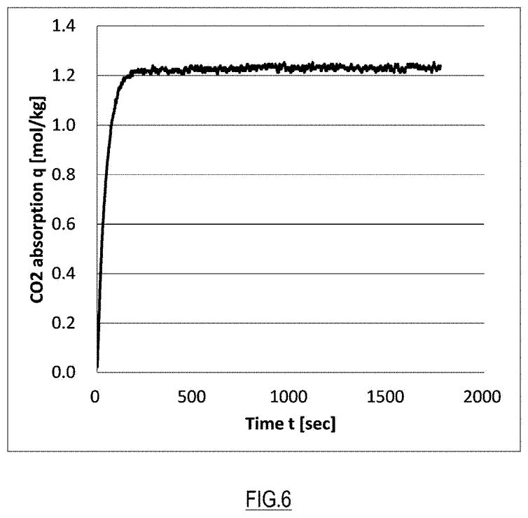

A time-lapse change of the amount of adsorbed carbon dioxide of the comparative sample was measured, and a carbon dioxide adsorption curve shown in the graph of FIG. 6 was obtained. In the graph of FIG. 6, a vertical axis denotes an adsorption amount q [mol/kg] that is the amount of carbon dioxide adsorbed, and a horizontal axis denotes an elapsed time t[s] since the contact of the comparative sample with the gas to be processed. It is shown by the carbon dioxide adsorption curve of the comparative sample that the adsorption of the carbon dioxide in the comparative sample became a substantially saturated state about 200 seconds after the contact of the comparative sample with the gas to be processed.

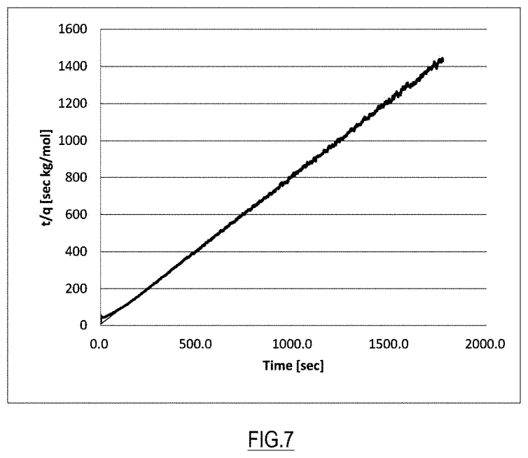

FIG. 7 shows a graph in which: a pseudo second order reaction model is applied to the above measurement result; a vertical axis denotes a parameter t/q obtained by dividing the time t by the adsorption amount q; and a horizontal axis denotes the time t. According to the intercept and gradient of a straight line shown in the graph, an overall mass transfer coefficient of the carbon dioxide adsorption was 3.10×10⁻⁶ [m/s]. Details of a method of calculating the overall mass transfer coefficient is described in “Chemical Engineering Journal”, Vol. 218, Pages. 350-357, Y Miyake et al. (15 Feb. 2013).”

Steps of mass transfer in the comparative sample include two steps that are boundary film mass transfer on the surface of the silica gel particle and gas diffusion at an adsorbing agent impregnated phase in the silica gel. A boundary film mass transfer coefficient can be estimated from numerical values described in “Chemical Engineering Handbook” edited by Society for Chemical Engineers, Japan and published by Maruzen Publishing Co., Ltd. The overall mass transfer coefficient can be decomposed into the mass transfer coefficients of the respective steps by using a series resistance model. Table 2 shows the mass transfer coefficient in the boundary film of the comparative sample, the mass transfer coefficient of the adsorbing agent impregnated phase of the comparative sample, and the overall mass transfer coefficient of the comparative sample.

Steps of the mass transfer in each of the samples 1 to 4 according to Verification Examples 1 to 4 include three steps that are boundary film mass transfer on the surface of the silica gel particle, gas diffusion at the adsorbing agent impregnated phase in the silica gel, and diffusion in the macropores. An effective diffusion coefficient corresponding to the pore diameter and porosity of the macropore was estimated from numerical values described in “Chemical Engineering Handbook” edited by Society for Chemical Engineers, Japan and published by Maruzen Publishing Co., Ltd., and the mass transfer coefficient was calculated by using the particle size as the diffusion length. The mass transfer coefficient of the adsorbing agent impregnated phase is set so as to be inversely proportional to the diffusion length in the phase, i.e., a characteristic length (which is thought to be equal to the pore diameter of the macropore) of a framework including the mesopores. The mass transfer coefficient in the boundary film does not depend on the internal structure of the porous material particle and is the same value among all the materials. For each of the samples 1 to 4, the mass transfer coefficients in the boundary film, the macropores, and an amine phase were synthesized by the series resistance model, and thus, the overall mass transfer coefficient was obtained. Table 2 shows the mass transfer coefficients in the boundary films of the samples 1 to 4, the mass transfer coefficients in the macropores of the samples 1 to 4, the mass transfer coefficients at the adsorbing agent impregnated phases of the samples 1 to 4, and the overall mass transfer coefficients of the samples 1 to 4.

TABLE 2

| | | Comparative | | | | |
|---|---|---|---|---|---|---|
| | | Sample | Sample 1 | Sample 2 | Sample 3 | Sample 4 |
| Mass | In boundary | 1.87 × 10⁻² | 1.87 × 10⁻² | 1.87 × 10⁻² | 1.87 × 10⁻² | 1.87 × 10⁻² |
| transfer | film | | | | | |
| coefficient | In | — | 3.52 × 10⁻⁴ | 3.97 × 10⁻⁴ | 4.03 × 10⁻⁴ | 1.06 × 10⁻⁴ |
| [m/s] | macropores | | | | | |
| | Adsorbing | 3.10 × 10⁻⁶ | 3.72 × 10⁻⁴ | 1.86 × 10⁻³ | 7.44 × 10⁻⁴ | 1.86 × 10⁻⁴ |
| | agent | | | | | |
| | impregnated | | | | | |
| | phase | | | | | |
| | Overall | 3.10 × 10⁻⁶ | 1.79 × 10⁻⁴ | 3.21 × 10⁻⁴ | 2.58 × 10⁻⁴ | 6.73 × 10⁻⁵ |

| | | | | |
|---|---|---|---|---|
| Ratio | 58 times | 104 times | 83 times | 22 times |

As shown in Table 2, each of the overall mass transfer coefficients of the samples 1 to 3 is about 20 to 100 times the overall mass transfer coefficient of the comparative sample. The overall mass transfer coefficient indicates the ease of diffusion transfer of a substance (herein, acid gas). Therefore, it is apparent that the ease of the diffusion transfer of the acid gas in the acid gas adsorbent that is each of the samples 1 to 3 including the support that is the porous material particle having the binary pores including the macropores and the mesopores improves more significantly than that in the acid gas adsorbent that is the comparative sample including the support that is the porous material particle having only the mesopores. Thus, it is confirmed that the adsorption speed and desorption speed of the acid gas in the acid gas adsorbent containing as the support the porous material particle having the binary pores improve more than those in the acid gas adsorbent containing as the support the porous material particle having only the mesopores.

### REFERENCE SIGNS LIST

1 acid gas adsorbent
2 porous material particle
3 acid gas adsorbing agent
21 macropore
22 mesopore

1. An acid gas adsorbent that reversibly adsorbs an acid gas contained in a gas to be processed,
the acid gas adsorbent comprising:
porous material particles; and
an acid gas adsorbing agent with which the porous material particles are impregnated, wherein:
each of the porous material particles has binary pores including
a mesopore having a pore diameter in a nanometer region of 2 nm or more and 200 nm or less and
a macropore having a pore diameter in a micrometer region of more than 0.2 μm;
the macropore is an empty pore; and
the mesopore is filled with the acid gas adsorbing agent.

2. The acid gas adsorbent according to claim 1, wherein an average particle size of the porous material particles is 1 mm or more and 5 mm or less.

3. The acid gas adsorbent according to claim 1, wherein a Log differential pore volume distribution of the porous material particles includes a first peak in a range of 10 nm or more and 200 nm or less and a second peak in a range of more than 0.2 μm and 10 μm or less.

4. The acid gas adsorbent according to claim 1, wherein the porous material particles are made of at least one selected from the group consisting of silica, alumina, titania, zirconia, and magnesia.

5. The acid gas adsorbent according to claim 1, wherein the acid gas adsorbing agent is at least one selected from the group consisting of alkanolamines and polyamines.

6. A method of manufacturing an acid gas adsorbent that reversibly adsorbs an acid gas contained in a gas to be processed,
the method comprising:
dissolving an acid gas adsorbing agent in a solvent to prepare an adsorbing agent solution;
impregnating porous material particles with the adsorbing agent solution; and
drying the porous material particles impregnated with the adsorbing agent solution by aeration or under reduced pressure, wherein
each of the porous material particles has binary pores including
a mesopore having a pore diameter in a nanometer region of 2 nm or more and 200 nm or less and
a macropore having a pore diameter in a micrometer region of more than 0.2 μm.

7. The method according to claim 6, wherein a concentration of the acid gas adsorbing agent of the adsorbing agent solution is represented by
αρx/(x+y) [Kg/m³]
where x [m³/Kg] denotes a pore volume of the mesopore, y [m³/Kg] denotes a pore volume of the macropore, ρ [Kg/m³] denotes a liquid density of the acid gas adsorbing agent, and α denotes an adjustment coefficient of 0.8 or more and 1.2 or less.

8. The method according to claim 6, wherein an average particle size of the porous material particles is 1 mm or more and 5 mm or less.

9. The method according to claim 6, wherein a Log differential pore volume distribution of the porous material particles includes a first peak in a range of 10 nm or more and 200 nm or less and a second peak in a range of more than 0.2 μm and 10 μm or less.

10. The method according to claim 6, wherein the porous material particles are made of at least one selected from the group consisting of silica, alumina, titania, zirconia, and magnesia.

11. The method according to claim 6, wherein the acid gas adsorbing agent is at least one selected from the group consisting of alkanolamines and polyamines.
